(19) United States
(12) Patent Application Publication
(10) Pub. No.: US 2026/0065722 A1
(43) Pub. Date: Mar. 5, 2026

(54) METHOD FOR AUTOMATICALLY POSITIONING AND ENERGY-SAVING FOR TIRE PRESSURE DETECTION SENSORS

(71) Applicants: WILLIAM DAVID STEWART, TAIPEI CITY (TW); CHIH-WEI YU, TAIPEI CITY (TW)

(72) Inventors: WILLIAM DAVID STEWART, TAIPEI CITY (TW); CHIH-WEI YU, TAIPEI CITY (TW)

(21) Appl. No.: 19/295,731

(22) Filed: Aug. 11, 2025

(30) Foreign Application Priority Data
Sep. 2, 2024 (TW) 113133124

(51) Int. Cl. G07C 5/04; B60C 23/04

(52) U.S. Cl. CPC G07C 5/04; B60C 23/0474; B60C 23/0488

(57) ABSTRACT

A method for automatically positioning and energy-saving for tire pressure detection sensors includes driving/parking mode determination, first and second parking advanced determination steps, message transmission comparison, and data reset steps. Through predefined threshold values (driving, parking, movement, automatic positioning, and movement variation interval values) within each tire pressure detection sensor, the system distinguishes between driving and parking modes. In parking mode, movement count of the tire pressure detection sensor in each tire is recorded and compared with the threshold values. The vehicle's host determines whether automatic positioning should be performed based on these comparisons, enabling positioning only under appropriate conditions. This saves power consumption of tire pressure detection sensors, eliminates unnecessary automatic positioning execution time, and provides immediate accurate tire information upon driving, achieving both time and energy savings.

### BACKGROUND OF THE INVENTION

### 1. Fields of the invention

The present invention relates to a method for automatically positioning and energy-saving, and more particularly, to technology applied in the field of tire pressure detection sensors to continuously determine whether the vehicle tires are in operation (moving, rolling, etc.) even when the tires are in a stationary state.

### 2. Descriptions of Related Art

Tire pressure detection sensors are one of the indispensable measuring devices on modern vehicles, capable of providing all tire information to drivers to ensure driving safety and protect the safety of others. However, general tire pressure detection sensors, when the vehicle is started and operating, are normally electrically connected to the vehicle's central control system and continuously transmit information. While this is indeed a safe mode for drivers, it undoubtedly consumes significant power for the tire pressure detection sensors, since the tires continue to send signals to the central control even when not moving or rolling, which is an operating mode that easily shortens the lifespan of electronic systems.

Furthermore, tire usage is not limited solely to vehicle applications. Sometimes during replacement or substitution operations, the tires are also subjected to rolling and moving operations. At such times, if the vehicle is in a started state, the tire pressure detection sensors within each tire will still maintain their message transmission state, continuously consuming power. The aforementioned conditions are not favorable for practitioners in this field.

The present invention intends to provide a method for automatically positioning and energy-saving for tire pressure detection sensors to eliminate the shortcomings mentioned above.

### SUMMARY OF THE INVENTION

The present invention relates to a method for automatically positioning and energy-saving for tire pressure detection sensors, the steps of the method comprising:
a driving/parking mode determination step: A plurality of tire pressure detection sensors located within a plurality of tires of a vehicle detecting movement of each tire, wherein each tire pressure detection sensor has a built-in acceleration unit to detect movement of each tire, each tire pressure detection sensor has a built-in driving threshold value, a parking threshold value, a movement threshold value, and a movement variation interval value located between the parking threshold value and the movement threshold value, wherein when a value detected by the acceleration unit of each tire pressure detection sensor is greater than the driving threshold value, a driving mode is defined, when a value detected by the acceleration unit of each tire pressure detection sensor is less than the parking threshold value, a parking mode is defined;
a first parking advanced determination step: When each tire pressure detection sensor enters the parking mode, each tire begins to perform actions, the acceleration unit of each tire pressure detection sensor activates detection, when a value detected by each acceleration unit is compared with the movement threshold value and the movement variation interval value, when the value of each acceleration unit is greater than the movement threshold value and exceed the movement variation interval value, a counting unit built in each tire pressure detection sensor determines that each tire is moving and performs cumulative counting, when the value of each acceleration unit is less than the movement threshold value or does not exceed the movement variation interval value, the counting unit within each tire pressure detection sensor does not perform cumulative counting and returns to each acceleration unit of each tire pressure detection sensor to continue detection;
a second parking advanced determination step: In the first parking advanced determination step, after the counting unit within each tire pressure detection sensor begins cumulative operation, the value detected by each acceleration unit is compared with the driving threshold value, when the value detected by each acceleration unit is greater than the driving threshold value, each tire pressure detection sensor transmits accumulated data from each counting unit to a host of the vehicle, when the value detected by each acceleration unit is less than the driving threshold value, each acceleration unit continues detection;
a message transmission comparison step: Following the above steps, after the host receives the accumulated data transmitted by each tire pressure detection sensor, the accumulated data is compared with an automatic positioning threshold value built in the host, when the accumulated data is less than the automatic positioning threshold value, the host does not perform automatic positioning with each tire pressure detection sensor, when the accumulated data is greater than the automatic positioning threshold value, automatic positioning is performed between the host and each tire pressure detection sensor, and
a data reset step: Following the above steps, the accumulated data of the counting unit of each tire pressure detection sensor is reset to zero, so as to facilitate the next re-execution of the driving/parking mode determination step.

The primary object of the present invention is to provide tire pressure detection sensors with the capability to determine the current state of tires and, after computation, further determine whether to perform automatic positioning, so as to ensure the power supply usage of the tire pressure detection sensors without causing unnecessary waste of power, thereby improving the deficiencies and problems brought about by conventional techniques.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a block diagram showing the steps of the present invention;

FIG. 2 is a block diagram of the driving/parking mode determination step of the present invention;

FIG. 3 is a block diagram of the first parking advanced determination step of the present invention;

FIG. 4 is a block diagram of the second parking advanced determination step of the present invention, and

FIG. 5 is a block diagram of the message transmission comparison step and data reset step of the present invention.

### DETAILED DESCRIPTION OF THE PREFERRED EMBODIMENT

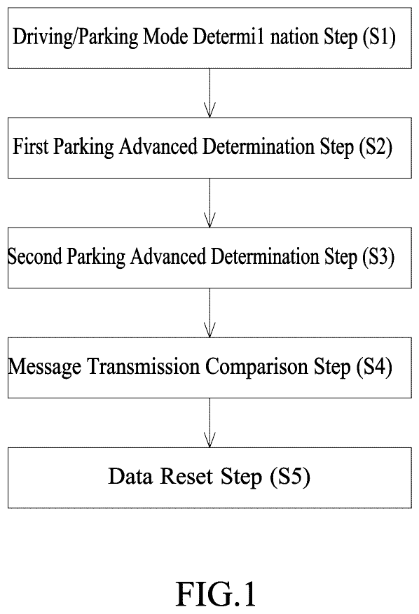

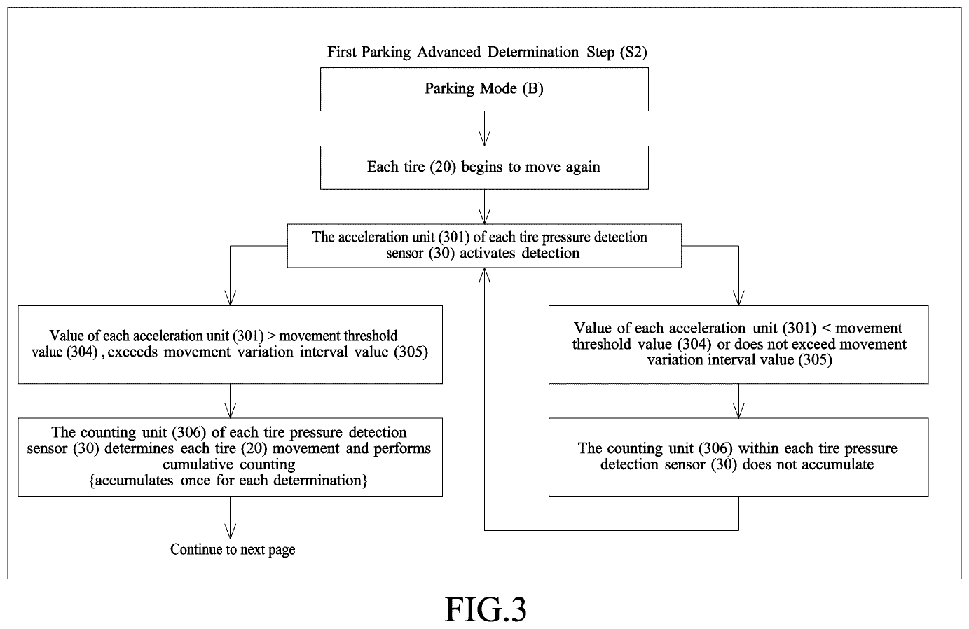

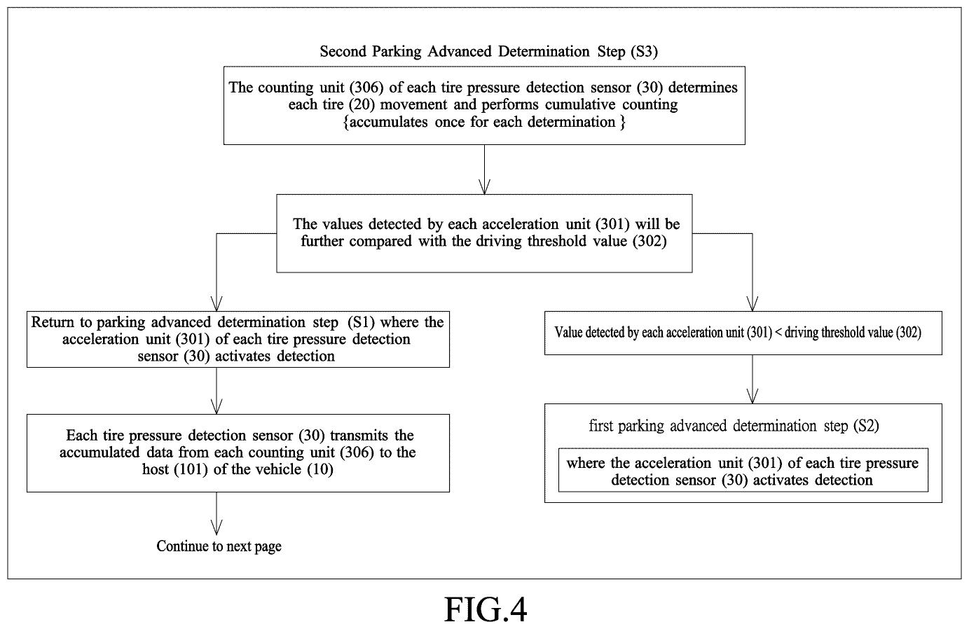

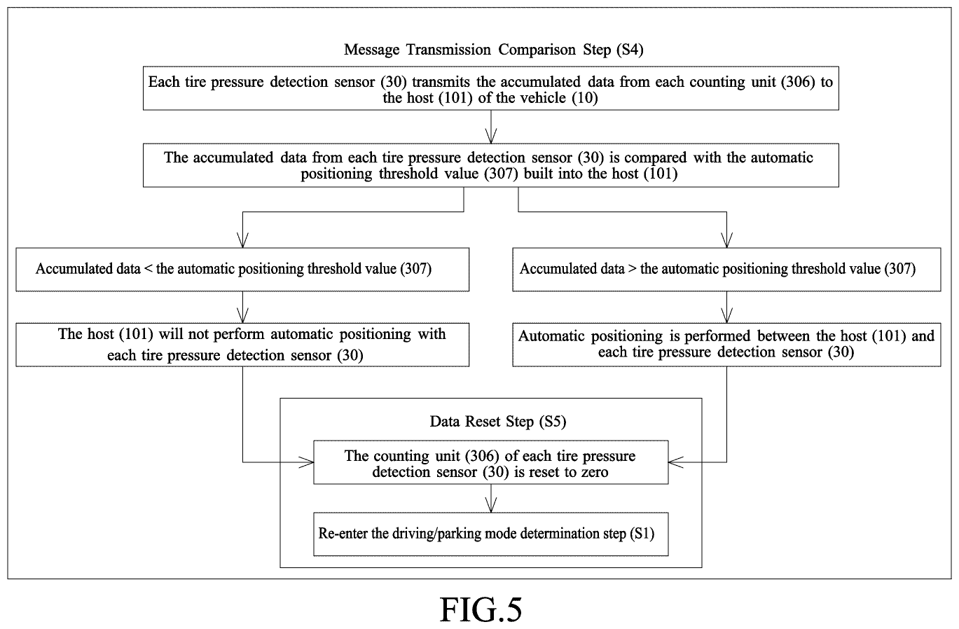

Referring to FIGS. 1 to 5, the method for automatically positioning and energy-saving for tire pressure detection sensors of the present invention comprises the following steps:
a driving/parking mode determination step S1: A plurality of tire pressure detection sensors 30 located within a plurality of tires 20 of a vehicle 10 detecting movement of each tire 20, wherein each tire pressure detection sensor 30 has a built-in acceleration unit 301 to detect movement of each tire 20, each tire pressure detection sensor 30 has a built-in driving threshold value 302, a parking threshold value 303, a movement threshold value 304, and a movement variation interval value 305 located between the parking threshold value 303 and the movement threshold value 304, wherein when a value detected by the acceleration unit 301 of each tire pressure detection sensor 30 is greater than the driving threshold value 302, a driving mode “A” is defined, when a value detected by the acceleration unit 301 of each tire pressure detection sensor 30 is less than the parking threshold value 303, a parking mode “B” is defined;
a first parking advanced determination step S2: When each tire pressure detection sensor 30 enters the parking mode “B”, each tire 20 begins to perform actions, the acceleration unit 301 of each tire pressure detection sensor 30 activates detection, when a value detected by each acceleration unit 301 is compared with the movement threshold value 304 and the movement variation interval value 305, when the value of each acceleration unit 301 is greater than the movement threshold value 304 and exceed the movement variation interval value 305, a counting unit 306 built in each tire pressure detection sensor 30 determines that each tire 20 is moving and performs cumulative counting, when the value of each acceleration unit 301 is less than the movement threshold value 304 or does not exceed the movement variation interval value 305, the counting unit 306 within each tire pressure detection sensor 30 does not perform cumulative counting and returns to each acceleration unit 301 of each tire pressure detection sensor 30 to continue detection;
a second parking advanced determination step S3: In the first parking advanced determination step S2, after the counting unit 306 within each tire pressure detection sensor 30 begins cumulative operation, the value detected by each acceleration unit 301 is compared with the driving threshold value 302, when the value detected by each acceleration unit 301 is greater than the driving threshold value 302, each tire pressure detection sensor 30 transmits accumulated data from each counting unit 306 to a host 101 of the vehicle 10, when the value detected by each acceleration unit 301 is less than the driving threshold value 302, each acceleration unit 301 continues detection;
a message transmission comparison step S4: Following the above steps, after the host 101 receives the accumulated data transmitted by each tire pressure detection sensor 30, the accumulated data is compared with an automatic positioning threshold value 307 built in the host 101, when the accumulated data is less than the automatic positioning threshold value 307, the host 101 does not perform automatic positioning with each tire pressure detection sensor 30, when the accumulated data is greater than the automatic positioning threshold value 307, automatic positioning is performed between the host 101 and each tire pressure detection sensor 30, and a data reset step S5: Following the above steps, the accumulated data of the counting unit 306 of each tire pressure detection sensor 30 is reset to zero, so as to facilitate the next re-execution of the driving/parking mode determination step S1.

When the vehicle 10 is in parking mode “B”, in order to determine whether to perform automatic positioning of the tire pressure detection sensors 30 in each tire 20 in a power-saving manner, the various threshold value settings defined on each tire pressure detection sensor 30 are used to determine whether the cumulative numerical value of the movement count of each tire 20 falls within the intervals of the aforementioned various threshold values. This enables precise determination of whether the current state of the tire 20 is that the vehicle is in a parking state or merely in temporary waiting (waiting at a traffic light), thereby activating or not activating the automatic positioning of each tire pressure detection sensor 30. In this way, the power supply usage can be effectively controlled while maintaining the service life of each tire pressure detection sensor 30.

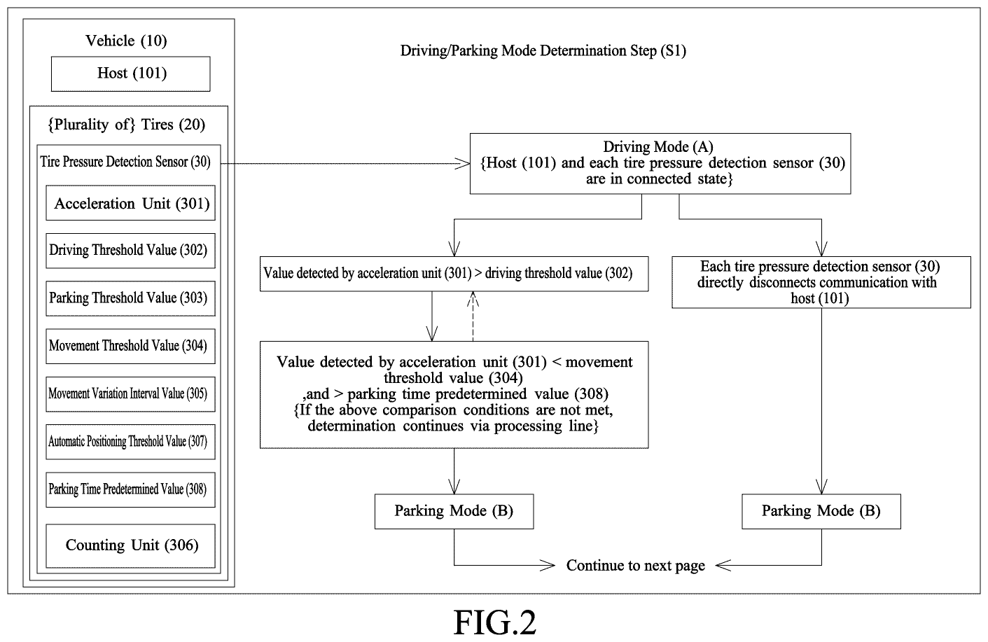

The present invention mainly has two methods under the determination of parking mode “B”. First, as shown in FIG. 2, initially in driving mode “A” of the driving/parking mode determination step S1, each tire pressure detection sensor 30 is in signal connection with the host 101. Then, when transitioning from driving mode “A” to parking mode “B”, the first state is that each tire pressure detection sensor 30 directly disconnects communication with the host 101. The second is a criteria-based determination, where the judgment criterion for driving mode “A” entering parking mode “B” is based on the acceleration unit 301 of each tire pressure detection sensor 30 performing acceleration detection on each tire 20. The values obtained after detection are compared with the driving threshold value 302. When the values are greater than the driving threshold value 302, they are further compared with the movement threshold value 304. When the values are less than the movement threshold value 304, and the time during which the values are less than the movement threshold value 304 exceeds a parking time predetermined value 308, the driving mode “A” transitions to parking mode “B”. When the values are less than the movement threshold value 304 but the time does not exceed the parking time predetermined value 308, it remains in driving mode “A”. According to the two judgment methods described above under parking mode “B”, they are primarily intended to enable precise and power-saving automatic positioning under parking mode “B”.

While we have shown and described the embodiment in accordance with the present invention, it should be clear to those skilled in the art that further embodiments may be made without departing from the scope of the present invention.

What is claimed is:

1. A method for automatically positioning and energy-saving for tire pressure detection sensors, the steps of the method comprising:
a driving/parking mode determination step: A plurality of tire pressure detection sensors located within a plurality of tires of a vehicle detecting movement of each tire, wherein each tire pressure detection sensor has a built-in acceleration unit to detect movement of each tire, each tire pressure detection sensor has a built-in driving threshold value, a parking threshold value, a movement threshold value, and a movement variation interval value located between the parking threshold value and the movement threshold value, wherein when a value detected by the acceleration unit of each tire pressure detection sensor is greater than the driving threshold value, a driving mode is defined, when a value detected by the acceleration unit of each tire pressure detection sensor is less than the parking threshold value, a parking mode is defined;
a first parking advanced determination step: When each tire pressure detection sensor enters the parking mode, each tire begins to perform actions, the acceleration unit of each tire pressure detection sensor activates detection, when a value detected by each acceleration unit is compared with the movement threshold value and the movement variation interval value, when the value of each acceleration unit is greater than the movement threshold value and exceed the movement variation interval value, a counting unit built in each tire pressure detection sensor determines that each tire is moving and performs cumulative counting, when the value of each acceleration unit is less than the movement threshold value or does not exceed the movement variation interval value, the counting unit within each tire pressure detection sensor does not perform cumulative counting and returns to each acceleration unit of each tire pressure detection sensor to continue detection;
a second parking advanced determination step: In the first parking advanced determination step, after the counting unit within each tire pressure detection sensor begins cumulative operation, the value detected by each acceleration unit is compared with the driving threshold value, when the value detected by each acceleration unit is greater than the driving threshold value, each tire pressure detection sensor transmits accumulated data from each counting unit to a host of the vehicle, when the value detected by each acceleration unit is less than the driving threshold value, each acceleration unit continues detection;
a message transmission comparison step: Following the above steps, after the host receives the accumulated data transmitted by each tire pressure detection sensor, the accumulated data is compared with an automatic positioning threshold value built in the host, when the accumulated data is less than the automatic positioning threshold value, the host does not perform automatic positioning with each tire pressure detection sensor, when the accumulated data is greater than the automatic positioning threshold value, automatic positioning is performed between the host and each tire pressure detection sensor, and
a data reset step: Following the above steps, the accumulated data of the counting unit of each tire pressure detection sensor is reset to zero, so as to facilitate the next re-execution of the driving/parking mode determination step.

2. The method as claimed in claim 1, wherein in the driving mode of the driving/parking mode determination step, each tire pressure detection sensor is in signal connection with the host.

3. The method as claimed in claim 2, wherein when transitioning from the driving mode to the parking mode in the driving/parking mode determination step, each tire pressure detection sensor directly disconnects communication with the host.

4. The method as claimed in claim 2, wherein a determination criterion for the driving mode entering the parking mode in the driving/parking mode determination step is based on the acceleration unit of each tire pressure detection sensor performing acceleration detection on each tire, obtained values are compared with the driving threshold value, when the obtained values are greater than the driving threshold value, the obtained values are further compared with the movement threshold value, when the obtained values are less than the movement threshold value, and a time during which the values are less than the movement threshold value exceeds a parking time predetermined value, the driving mode transits to the parking mode, when the time during which the obtained values are less than the movement threshold value does not exceed the parking time predetermined value, the driving mode is remained.
